(19) United States
(12) Patent Application Publication
(10) Pub. No.: US 2012/0325388 A1
(43) Pub. Date: Dec. 27, 2012

(54) Tire Containing an Antioxidant Reservoir

(76) Inventors: David Lavalle, Clermont-Ferrand (FR); Philippe Tramond, Saint-Ours-Les-Roches (FR); Eric Berger, Loubeyrat (FR); Jacques Besson, Chamalieres (FR)

(21) Appl. No.: 13/499,602

(22) PCT Filed: Sep. 28, 2010
(86) PCT No.: PCT/EP2010/064350

§ 371 Date: Aug. 13, 2012

Related U.S. Application Data
(60) Provisional application No. 61/287,523, filed on Dec. 17, 2009.

(30) Foreign Application Priority Data
Sep. 30, 2009 (FR) 0956776

(51) Int. Cl. B60C 9/28

(52) U.S. Cl. 152/527; 152/526

(57) ABSTRACT

A tire comprising: two beads intended to come into contact with a mounting rim; two sidewalls extending the beads radially outward, the two sidewalls joining in a crown comprising a crown reinforcement extending axially between two axial ends and surmounted by a tread; and a carcass reinforcement anchored in the two beads and extending through the sidewalls to the crown, wherein the crown includes, radially to the inside of the carcass reinforcement, at least one reservoir layer made of a rubber mix having a high antioxidant content, so that at least one reservoir layer is radially plumb with each axial end of the crown reinforcement, wherein said at least one reservoir layer has an antioxidant content equal to or greater than 5 phr but does not exceed 10 phr, and wherein said at least one reservoir layer further includes an oxygen absorbent.

### RELATED APPLICATION

This is a U.S. National Phase application under 35 USC 371 of International Application PCT/EP2010/064350, filed on Sep. 28, 2010.

This application claims the priority of French patent application Ser. No. 09/56776 filed Sep. 30, 2009 and U.S. provisional patent application No. 61/287,523 filed Dec. 17, 2009, the entire content of both of which are hereby incorporated by reference.

### FIELD OF THE INVENTION

The present invention relates to tires containing an antioxidant reservoir

### BACKGROUND OF THE INVENTION

Among the factors that may limit the lifetime of a tire is the internal oxidation of the various components of the tire, and more particularly the internal oxidation caused by oxygen coming from the gas inflating the tire.

This is because the essentially unsaturated diene rubber vulcanizates, whether natural or synthetic rubber vulcanizates, are liable to deteriorate relatively rapidly after prolonged exposure to oxygen because of the presence of double bonds in their molecular chains. These complex mechanisms have been discussed, for example, in the documents U.S. Pat. No. 6,344,506 and WO 99/06480. They result, after breaking of said double bonds and oxidation of the sulphur bridges, in rigidification and embrittlement of the vulcanizates, which degradation is further accelerated through the concomitant action of heat by undergoing “thermal oxidation” or else through the action of light by undergoing “photo-oxidation”.

It has been proposed to limit any oxidation due to oxygen coming from the tire inflation gas by inflating the tire with an inert gas, such as nitrogen. However, this solution comes up against the higher cost that it incurs and the difficulty of supplying nitrogen at any site. Faced with these drawbacks, it has therefore been proposed to continue inflating a tire with air and to provide, inside the tire, rubber mix portions containing oxygen absorbents. Document WO 2005/097522 describes several ways of implementing this solution.

It has been possible to gradually inhibit the phenomenon of oxidation through the development and commercialization of various antioxidants, including in particular p-phenylenediamine derivatives (PPD or PPDA), such as for example N-isopropyl-N′-phenyl-p-phenylenediamine (I-PPD) or N-1,3-dimethylbutyl-N′-phenyl-p-phenylenediamine (6-PPD), and quinoline derivatives (TMQ), which are both excellent antioxidants and antiozonants (see for example documents US 2004/0129360 and WO 2005/063510). At the present time, these antioxidants are used systematically in diene rubber compositions, in particular in compositions for tires, so as to slow down the aging thereof.

A well-known drawback of these antioxidants is the fact that their concentration in rubber compositions naturally decreases over the course of time through their very chemical function. They also have a high natural propensity to migrate from the zones with a higher antioxidant concentration to the zones with a lower antioxidant concentration. Tire manufacturers are, therefore, forced to use relatively large amounts of product, which is relatively expensive and also detractive to the appearance of the end products because of the high staining power of a large number of antioxidants, especially p-phenylenediamine derivatives.

To alleviate the abovementioned drawbacks and thus further improve the aging protection/resistance of tires, it has been proposed in particular to incorporate into these tires additional layers of a rubber mix having a higher antioxidant content, which act as antioxidant reservoirs capable of delivering the antioxidant over the course of time, by migration, according to the degree of depletion in the adjacent zones.

Document U.S. Pat. No. 7,082,976 provides a tread made up of two layers having different antioxidant contents. The radially inner layer has a higher antioxidant content, thereby enabling it to deliver antioxidant into the radially outer layer which is more greatly exposed to the effect of oxygen and, therefore, has a tendency to be more rapidly depleted thereof. This solution has nevertheless the drawback that it is essentially the radially outer portion of the tread that is supplied with antioxidant, whereas other critical zones, such as the shoulders of the tire, are supplied to only a small extent.

Document WO 2009/029114 also provides one or more antioxidant reservoirs and diffusion barriers in the tread, so as to deliver, in a targeted manner, the antioxidant into at least one shoulder of the tire. This solution nevertheless requires a complex composite structure of the tread and has a high cost.

### SUMMARY OF THE INVENTION

One of the objectives of the present invention is to provide a tire that includes antioxidant reservoirs positioned so as, in particular, to protect the axial ends of the crown reinforcement, these being the preferential site for initiating cleavage-type cracking phenomena.

This objective is achieved by one aspect of the invention directed to a tire comprising:

two beads intended to come into contact with a mounting rim;

two sidewalls extending the beads radially outwards, the two sidewalls joining in

a crown comprising a crown reinforcement extending axially between two axial ends and surmounted by a tread; and

a carcass reinforcement anchored in the two beads and extending through the sidewalls to the crown,

wherein the crown includes, radially to the inside of the carcass reinforcement, at least one reservoir layer made of a rubber mix having a high antioxidant content, so that at least one reservoir layer is radially plumb with each axial end of the crown reinforcement,
wherein said at least one reservoir layer has an antioxidant content that is equal to or greater than 5 phr but does not exceed 10 phr,
and wherein said at least one reservoir layer further includes an oxygen absorbent.

The disposition of the reservoir layer on the inside of the carcass reinforcement radially plumb with each axial end of the crown reinforcement makes it possible to optimize the use of the antioxidant. In the first place, the antioxidant diffuses toward the axial ends of the crown reinforcement and not toward the axial middle of the tread, where it is less useful. The place chosen for the reservoir layers allows them to have a high loading of antioxidant, since these layers do not play a mechanical role in the operation of the tire. If the reservoir layers were to be placed radially to the outside of the carcass reinforcement, for example in the tread or around the ends of the crown reinforcement, it would be necessary to limit the antioxidant content so as to obtain rubber mixes capable of fulfilling the mechanical role of the rubber mixes normally used in these zones of the tire.

The antioxidant content of the reservoir layer does not exceed 10 phr since, at higher contents, the antioxidant content of the adjacent portions of the tire would increase to the point of impairing their mechanical properties.

As the reservoir layer contains an oxygen absorbent, it constitutes both a physical barrier and a chemical barrier, enabling the oxygen migration to be slowed down and to reduce the deleterious effect thereof.

It should be noted that a tire according to an embodiment of the invention benefits from a synergy between antioxidant and oxygen absorbent substances, which could not have been obtained if only antioxidants or only oxygen absorbers had been used: the oxygen absorbent traps diffusing oxygen whereas the antioxidant renders it inoffensive. If the reservoir layer contained only oxygen absorbents, the oxygen could still have local effects; if the layer contained only antioxidants, there would be a greater risk that the oxygen did not encounter an antioxidant before it produced its deleterious effect on the rubber mix.

Preferably, the antioxidant of the reservoir layer consists predominantly of a compound chosen from the group formed by N-1,3-dimethylbutyl-N′-phenyl-p-phenylenediamine (6-PPD), N-isopropyl-N′-phenyl-p-phenylenediamine (I PPD), and mixtures of these compounds, since these antioxidants are particularly effective.

As regards the geometry of the reservoir layer, it is preferable for the average radial thickness of said reservoir layer to be equal to or greater than 0.6 mm and preferably equal to or greater than 1 mm. In particular, this makes it easier to position said layer because a smaller average radial thickness would result in a low mechanical strength in the uncured state and make it difficult to position it.

Preferably, the maximum radial thickness of the reservoir layer does not exceed 5 mm, and preferably does not exceed 3 mm. This is because it has been found that, for larger radial thicknesses, the reservoir layer has an unfavorable effect on the operation of the tire. In particular, an unfavorable thermal effect is observed, due to the fact that the reservoir constitutes an additional source of energy dissipation. As a result, the additional heat-up of the materials of the tire leads to an increase in their crack rate.

Preferably, the axial width of the reservoir layer is equal to or greater than 20 mm, and preferably equal to or greater than 30 mm. This axial width ensures that the reservoir layer will supply the zone in which the axial end of the crown reinforcement associated therewith lies, since such a width makes it possible to overcome any uncertainty in positioning said layer.

According to an advantageous embodiment, the reservoir layer extends axially from one axial end of the crown reinforcement to the other axial end of the crown reinforcement. Thus, the reservoir layer protects the crown reinforcement over its entire width.

According to another advantageous embodiment, the tire includes at least two reservoir layers, at least one of said reservoir layers being placed on either side of the median plane of the tire. In this embodiment, the two axial ends (which are mechanical transition zones much more highly stressed than the center of the crown) are more effectively protected, while limiting the volume of the reservoir layer and, as a consequence, the total amount of antioxidant and the manufacturing cost of the tire.

It is therefore particularly advantageous for the axial width of each of the reservoir layers not to exceed 100 mm, and preferably not to exceed 60 mm. This constitutes a very good compromise between the volume of the layers and ease of manufacture.

Ideally, each of said at least two reservoir layers extends axially over at least 15 mm on either side of an axial end of the crown reinforcement. The axial ends of the crown reinforcement are thus protected particularly effectively.

### BRIEF DESCRIPTION OF THE DRAWINGS

FIGS. 1 and 2 show schematically a tire according to the prior art.

FIGS. 3 and 4 show schematically, in radial section, a portion of a reference tire used for comparative tests against a tire made according to an embodiment of the invention.

FIGS. 5 to 9 show schematically, in radial section, a portion of a tire according to different embodiments of the invention.

### DETAILED DESCRIPTION OF THE DRAWINGS

It is necessary to distinguish between several different uses of the term “radial” by those skilled in the art. In the first place, the expression refers to a radius of the tire. According to this meaning, a point P1 is said to be “radially internal” to a point P2 (or “radially to the inside” of the point P2) if it is closer to the rotation axis of the tire than the point P2. Conversely, a point P3 is said to be “radially external” to a point P4 (or “radially to the outside” of the point P4) if it is further away from the rotation axis of the tire than the point P4. A “radially inward (or outward)” movement refers to a movement in the direction of smaller (or larger) radii. When referring to radial distances, this meaning of the term also applies.

When an element of the tire is said to be “radially plumb” with a point P1, it should be understood by this that a radial direction passing through this point P1 intersects said element of the tire and that this intersection lies between the point P1 and the axis of the tire.

On the other hand, a thread or a reinforcement is said to be “radial” when the thread or the reinforcing elements of the reinforcement makes or make an angle greater than or equal to 80° to the circumferential direction, but said angle not exceeding 90°. It should be pointed out that, in the present document, the term “thread” must be understood in a very general sense and to comprise threads in the form of a monofilament, a multifilament, a cord, a yarn or an equivalent assembly, whatever the constituent material of the thread or the surface treatment to bond it more strongly to the rubber.

Finally, the term “radial section” or “radial cross-section” is understood to mean here a section or cross-section in a plane that contains the rotation axis of the tire.

An “axial” direction is a direction parallel to the rotation axis of the tire. A point P5 is said to be “axially internal” to a point P6 (or “axially to the inside” of the point P6) if it is closer to the median plane of the tire than the point P6. Conversely, a point P7 is said to be “axially external” to a point P8 (or “axially to the outside” of the point P8) if it is further away from the median plane of the tire than the point P8. The “median plane” of the tire is the plane which is perpendicular to the rotation axis of the tire and which lies equidistant from the circumferential reinforcements of each bead.

A “circumferential” direction is a direction perpendicular both to a radius of the tire and to the axial direction. A “circumferential section” is a section in a plane perpendicular to the rotation axis of the tire.

The expression “rolling surface” is understood here to mean the set of points on the tread of a tire that come in contact with the ground when the tire is rolling.

The expression “rubber mix” denotes a rubber composition comprising at least one elastomer and at least one filler.

For the sake of ease of reading, the same references are used to denote identical structural elements.

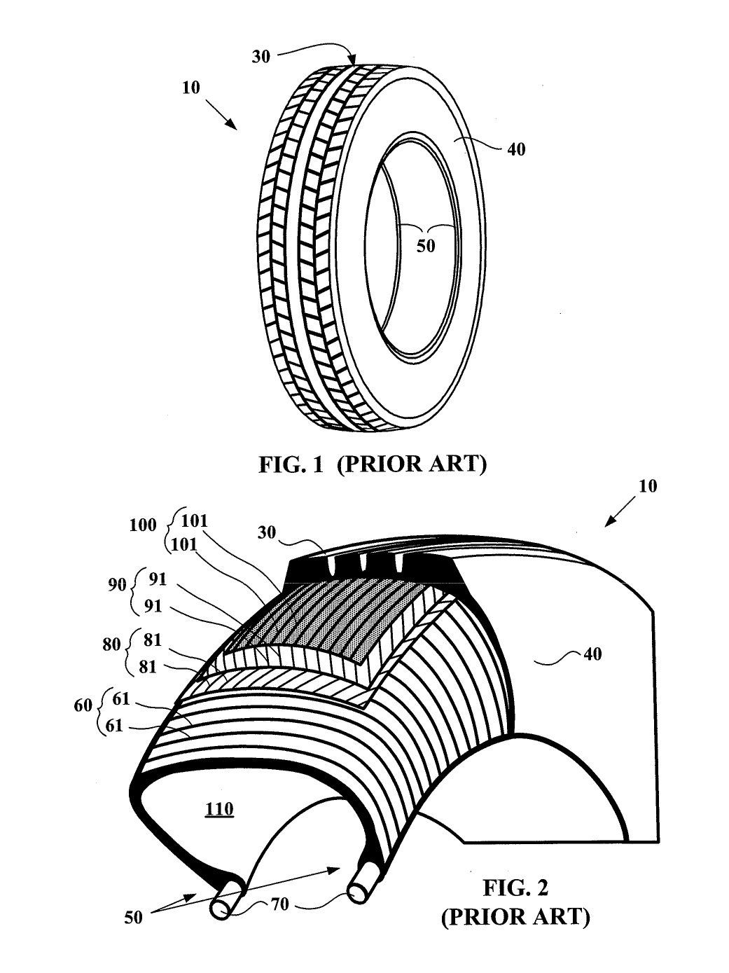

FIG. 1 shows schematically a tire 10 according to the prior art. The tire 10 comprises two beads 50 intended to come into contact with a mounting rim (not shown), and two sidewalls 40 extending the beads 50 radially outwards, the two sidewalls 40 joining in a crown comprising a crown reinforcement (not visible in FIG. 1) that is surmounted by a tread 30.

FIG. 2 shows schematically a partial perspective view of a tire 10 according to the prior art and illustrates the various components of the tire. Again, the tire 10 comprises two beads 50 intended to come into contact with a mounting rim (not shown), and two sidewalls 40 extending the beads 50 radially outward, the two sidewalls 40 joining in a crown comprising a crown reinforcement that is surmounted by a tread 30. The crown reinforcement here comprises two plies 80 and 90. Each of the plies 80 and 90 is reinforced by reinforcing threads 81 and 91 that are parallel in each ply and crossed from one ply to the other, making angles of between 10° and 70° with the circumferential direction.

The tire 10 also includes a carcass reinforcement 60 consisting of threads 61 coated with a rubber mix. The carcass reinforcement 60 is anchored in each of the beads 50 to circumferential reinforcements 70 (here, bead wires) which hold the tire 10 in position on the rim (not shown).

The tire further includes a hooping reinforcement 100, placed radially to the outside of the crown reinforcement, this hooping reinforcement being formed from reinforcing elements 101 oriented circumferentially and wound in a spiral.

The tire 10 shown is a tubeless tire—it includes an inner liner 110 made of a rubber composition impermeable to the inflation gas and covering the internal surface of the tire.

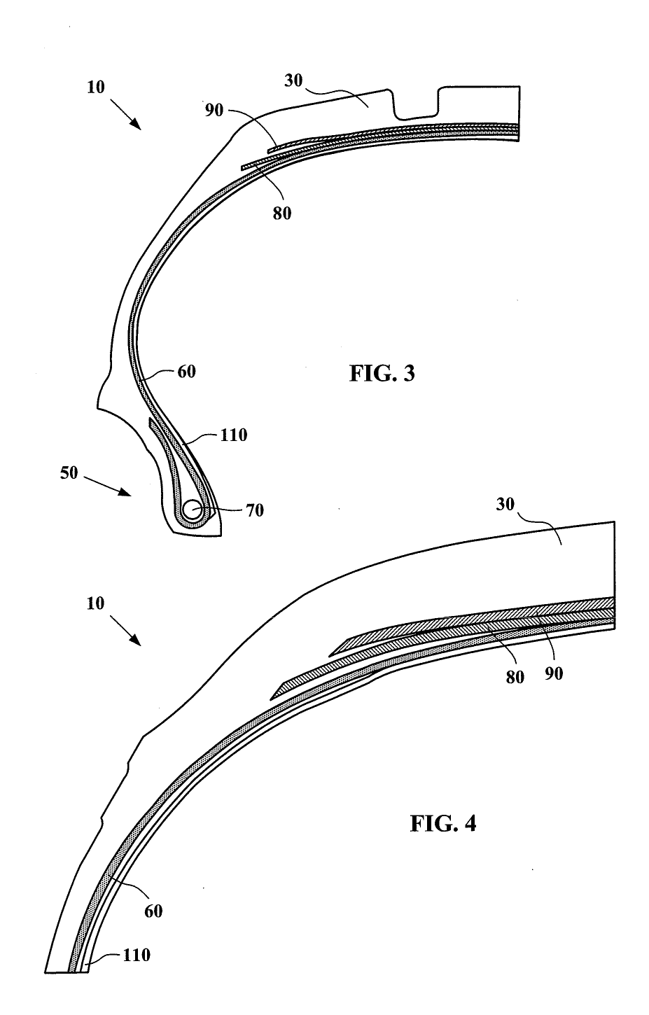

FIGS. 3 and 4 show schematically, in radial section, a portion of a reference tire 10.

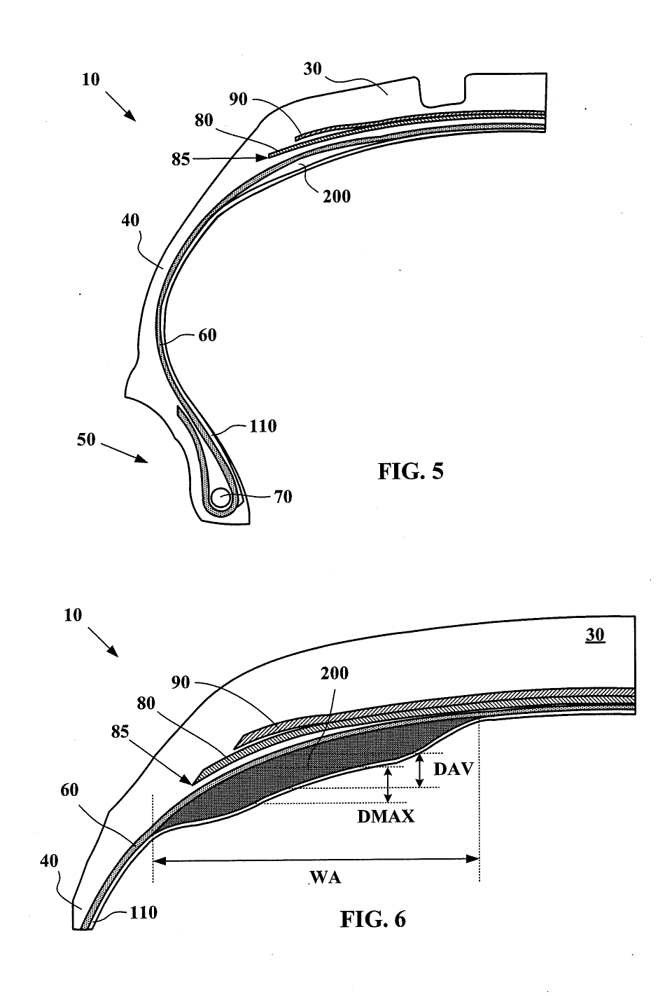

FIG. 5 shows, in radial section, a portion of a tire 10 according to an embodiment of the invention. The tire 10 comprises two beads 50 intended to come into contact with a mounting rim (not shown), and two sidewalls 40 extending the beads 50 radially outwards, the two sidewalls 40 joining in a crown comprising a crown reinforcement formed from two reinforcing plies or layers 80 and 90. The crown reinforcement extends axially between two axial ends, only one of which, bearing the reference 85, is visible. It is surmounted by a tread 30. The tire 10 also includes a carcass reinforcement 60 anchored in the two beads 50 and extending through the sidewalls 40 to the crown.

The crown includes, radially to the inside of the carcass reinforcement 60, a reservoir layer 200 made of a rubber mix having a high antioxidant content. The reservoir layer is radially plumb with the axial end 85 of the crown reinforcement. This reservoir layer 200 is made of a rubber mix having an antioxidant content equal to or greater than 5 phr. An example of such a rubber mix is given below.

FIG. 6 shows, in radial section, a portion of another tire 10 according to an embodiment of the invention. Here, the reservoir layer 200 has an average radial thickness DAV equal to 3 mm and a maximum radial thickness DMAX equal to 3.5 mm. The axial width WA of the reservoir layer 200 is equal to 35 mm.

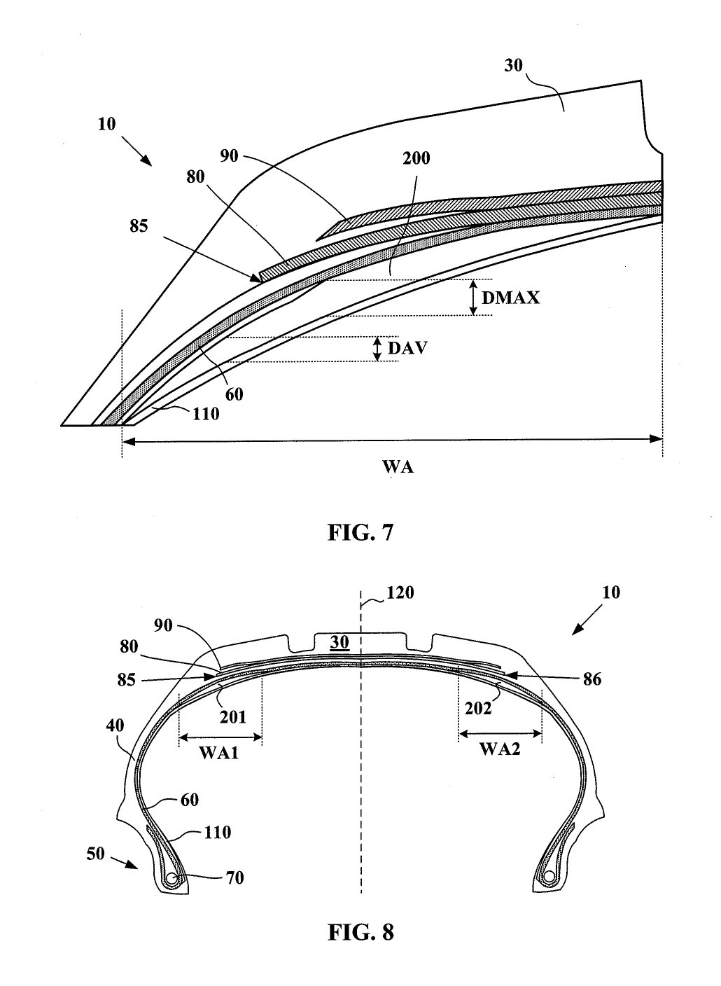

FIG. 7 shows, in radial section, a portion of another tire 10 according to an embodiment of the invention. The reservoir layer 200 is thinner than that of the tire of FIG. 6, but extends further. The average radial thickness DAV is 1.7 mm, the maximum radial thickness DMAX is 2.8 mm and the axial width WA of the reservoir layer 200 is equal to 50 mm.

FIG. 8 shows, in radial section, a portion of a tire 10 according to an embodiment of the invention which is similar to that shown in FIG. 5. It may be seen that the tire 10 has two reservoir layers 201 and 202, one reservoir layer being placed on each side of the median plane 120 of the tire. In this case, the two reservoir layers have the same axial width WA=WA1=WA2=30 mm. Each of the reservoir layers 200 extends axially by 15 mm on either side of the corresponding axial end 85 or 86 of the crown reinforcement. The reservoir layers 200 are therefore centered axially with respect to an axial end of the crown reinforcement.

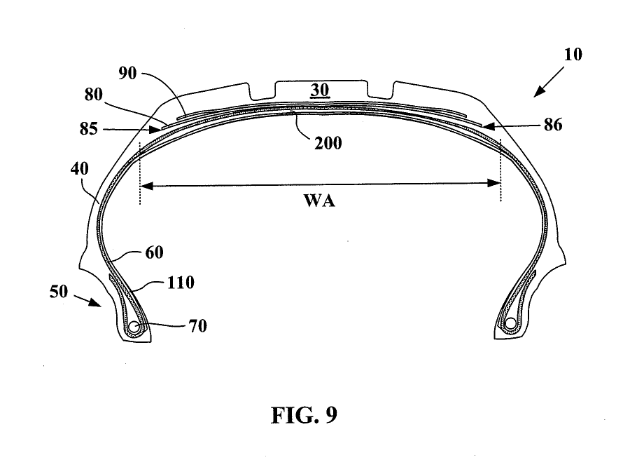

FIG. 9 shows, in radial section, a portion of another tire 10 according to an embodiment of the invention. Unlike the reservoir layers 200 of the tire shown in FIG. 8, the reservoir layer 200 here extends axially from one axial end 85 of the crown reinforcement to the other axial end 86 of the crown reinforcement formed by the plies 80 and 90. The axial width WA is 135 mm.

The formulation and the production of a rubber mix having an antioxidant content equal to or greater than 5 phr but not exceeding 10 phr pose no particular problems to those skilled in the art. Table 1 lists the composition of a rubber mix that can be used. The composition is given in phr (Parts per Hundred Rubber), i.e. in parts by weight per 100 parts of elastomer by weight.

TABLE 1

| | Mix M according to |
|---|---|
| Parts in phr | an embodiment of the invention |
| NR [1] | 100 |
| N 683 | 60 |
| Antioxidant (6PPD) [2] | 5 |
| O2 Absorbent [3] | 0.1 |
| Stearic acid | 0.5 |
| ZnO | 3 |
| Sulphur | 3 |
| Accelerator (CBS) [4] | 1.5 |

Annotations for Table 1:
[1] Natural rubber
[2] N-(1,3-dimethylbutyl)-N′-phenyl-p-phenylenediamine
[3] Acac FeIII
[4] N-cyclohexyl-2-benzothiazole sulphenamide.

The rubber mix is preferably based on at least: a diene elastomer, a reinforcing filler and a crosslinking system.

The term “diene” elastomer (or equivalently rubber), is understood to mean, as is known, an elastomer obtained at least in part (i.e. a homopolymer or a copolymer) from diene monomers, i.e. monomers carrying two carbon-carbon double bonds, whether or not these are conjugated. The diene elastomer used is preferably chosen from the group consisting of polybutadienes (BR), natural rubber (NR), synthetic polyisoprenes (IR), butadiene-stirene copolymers (SBR), isoprene-butadiene copolymers (BIR), isoprene-stirene copolymers (SIR), butadiene-stirene-isoprene copolymers (SBIR) and blends of these elastomers.

In a preferred embodiment, an “isoprene” elastomer is used, i.e. an isoprene homopolymer or an isoprene copolymer, in other words a diene elastomer chosen form the group formed by natural rubber (NR), synthetic polyisoprenes (IR), various isoprene copolymers and blends of these elastomers.

The isoprene elastomer is preferably natural rubber or a synthetic polyisoprene of the cis-1,4 type. Among these synthetic polyisoprenes, it is preferred to use polyisoprenes having a content (mol %) of cis-1,4 bonds of greater than 90% and even more preferably greater than 98%. According to other preferred embodiments, the diene elastomer may consist, entirely or partly, of another diene elastomer such as, for example, an SBR (E-SBR or S-SBR) elastomer optionally blended with another elastomer, for example of the BR type.

A rubber mix “according to the invention” (by this is meant a rubber mix that can be used to form the reservoir layer of a tire according to an embodiment of the invention) has an antioxidant content equal to or greater than 5 phr.

The antioxidant used in the composition of the invention is any antioxidant known to be effective in preventing the aging of rubber vulcanizates that can be attributed to the action of oxygen.

In particular, the following antioxidants may be used: derivatives of para-phenylenediamine (abbreviated to PPD or PPDA), or what are known to be called substituted para-phenylenediamines such as, for example, N-1,3-dimethylbutyl-N′-phenyl-p-phenylenediamine (known more by the abbreviation 6-PPD), N-isopropyl-N′-phenyl-p-phenylenediamine (abbreviated to I—PPD), phenylcyclohexyl-p-phenylene-diamine, N,N′-di(1,4-dimethylpentyl)-p-phenylenediamine, N,N′-diaryl-p-phenylene-diamine (DTPD), diaryl-p-phenylenediamine (DAPD), 2,4,6-tris-(N-1,4-dimethylpentyl-p-phenylenediamino)-1,3,5-triazine, and mixtures of such diamines.

It is also possible to use quinoline (TMQ) derivatives such as, for example, 1,2-dihydro-2,2,4-trimethylquinoline and 6-ethoxy-1,2-dihydro-2,2,4-trimethyl-quinoline.

Use may also be made of substituted diphenylamines and triphenylamines, such as those described for example in Patent Applications WO 2007/121936 and WO 2008/055683, in particular 4,4′-bis(isopropylamino)triphenylamine, 4,4′-bis(1,3-dimethylbutylamino)triphenylamine, and 4,4′-bis(1,4-dimethylpentylamino)triphenylamine.

One may also use dialkylthiodipropionates, or phenolic antioxidants especially of the family of 2,2′-methylene-bis-4-(C₁-C₁₀)alkyl-6-(C₁-C₁₂)alkylphenols, such as those described in particular in Patent Application WO 99/02590.

Of course, in the present description, the term antioxidant may denote both a single antioxidant compound or a mixture of several antioxidant compounds.

Preferably, the antioxidant is chosen from the group formed by substituted p-phenylenediamines, substituted diphenylamines, substituted triphenylamines, quinoline derivatives and mixtures of such compounds. Even more preferably, the antioxidant is chosen from the group formed by substituted p-phenylenediamines and mixtures of such diamines.

The reservoir layer further includes an oxygen absorbent, such as a metal salt. This metal salt is preferably selected from the first series, the second series or the third series of transition metals of the Periodic Table, or from the lanthanides.

The metals may for example be manganese II or III, iron II or III, cobalt II or III, copper I or II, rhodium II, III or IV and ruthenium. The oxidation state of the metal when it is introduced is not necessarily that of the cationic active form. The metal is preferably manganese, nickel or copper, more preferably cobalt and even more preferably iron. The counterion for the metal is particularly chloride, acetate, stearate, palmitate, 2-ethylhexanoate, neodecanoate or naphthenate.

Preferably, the amount of the metal compound in the composition lies within the range from 0.01 to 0.3 phr and even more preferably in the range from 0.05 to 0.15 phr.

The rubber composition may also include some or all of the standard additives conventionally used in rubber matrices intended for the manufacture of tires, such as, for example reinforcing fillers, such as a carbon black other than the aforementioned carbon black, or inorganic fillers such as silica, coupling agents for coupling inorganic filler, anti-aging agents, plasticizers or extender oils, whether the latter are of aromatic or non-aromatic nature (especially non-aromatic or very slightly aromatic oils, for example of the naphthenic or paraffinic type, having a high, or preferably a low, viscosity, MES or TDAE oils, plasticizing resins having a high T_{g}, namely above 30° C.), processing aids making it easier to process the compositions in the uncured state, tackifying resins, a crosslinking system based either on sulphur or on sulphur donors and/or peroxides, accelerators, vulcanization activators or retarders, antireversion agents, methylene acceptors and donors such as, for example, HMT (hexamethylenetetramine) or H3M (hexamethoxymethylmelamine), reinforcing resins (such as resorcinol or bismaleimide), and known adhesion promoters, for example of the metal salt type, especially cobalt, nickel or lanthanide salts.

The compositions are manufactured in suitable mixers, using two successive preparation phases well-known to those skilled in the art, namely a first, thermomechanical working or kneading phase (called the “non-productive” phase) at high temperature, up to a maximum temperature of between 110° C. and 190° C., preferably between 130° C. and 180° C., followed by a second, mechanical working phase (called the “productive” phase) up to a lower temperature, typically below 110° C., during which finishing phase the crosslinking system is incorporated.

To give an example, the non-productive phase is carried out in a single thermomechanical step lasting a few minutes (for example between 2 and 10 minutes) during which all the necessary basic constituents and other additives, with the exception of the crosslinking or vulcanization system, are introduced into a suitable mixer, such as a standard internal mixer. After the mixture thus obtained has cooled down, the vulcanization system is then incorporated in an external mixer, such as a two-roll mill, maintained at low temperature (for example between 30° C. and 100° C.). All the ingredients are then mixed (during the productive phase) for a few minutes (for example between 5 and 15 minutes).

The final composition thus obtained is then calendered, for example in the form of a sheet for characterization, or else extruded, to form the outer tread that can be used in a tire according to an embodiment of the invention.

The vulcanization (or curing) may then be carried out in a known manner, generally at a temperature between 130° C. and 200° C., preferably under pressure, for a sufficient time, which may for example vary between 5 and 90 minutes depending in particular on the curing temperature, on the vulcanization system adopted and on the rate of vulcanization of the composition in question.

In order to compare the tires according to an embodiment of the invention with reference tires without a reservoir layer having an antioxidant content equal to or greater than 5 phr, endurance tests were carried out. The tires were mounted on a wheel and inflated to their service pressure. They were then rapidly rotated, under load, on a rolling drum having a surface provided with obstacles (bars and protrusions). The test was stopped as soon as significant deformation of the tire crown was observed. The following kilometer distances were obtained: 24646 km (reference tire) and 32576 km (tire corresponding to FIG. 6, having a reservoir layer made of a rubber mix M (see Table 1)). The greater endurance obtained with tires having a reservoir layer according to an embodiment of the invention was also reflected in a dramatic decrease of cracks that became visible in the tire shoulders after the test. The reservoir layers therefore make it possible to achieve greater endurance, although they contribute to a significant increase in the operating temperature at the ends of the crown reinforcements.

1. A tire comprising:
two beads intended to come into contact with a mounting rim;
two sidewalls extending the beads radially outwards, the two sidewalls joining in
a crown comprising a crown reinforcement extending axially between two axial ends and surmounted by a tread; and
a carcass reinforcement anchored in the two beads and extending through the sidewalls to the crown,
wherein the crown includes, radially to the inside of the carcass reinforcement, at least one reservoir layer made of a rubber mix having a high antioxidant content, so that at least one reservoir layer is radially plumb with each axial end of the crown reinforcement,
wherein said at least one reservoir layer has an antioxidant content that is equal to or greater than 5 phr but does not exceed 10 phr,
and wherein said at least one reservoir layer further includes an oxygen absorbent.

2. The tire according to claim 1, wherein the antioxidant of said at least one reservoir layer consists predominantly of a compound chosen from the group formed by N-1,3-dimethylbutyl-N′-phenyl-p-phenylenediamine (6-PPD), N-isopropyl-N′-phenyl-p-phenylenediamine (I PPD), and mixtures of these compounds.

3. The tire according to claim 1, wherein the average radial thickness DAV of said reservoir layer is equal to or greater than 0.6 mm.

4. The tire according to claim 1, wherein the maximum radial thickness DMAX of said reservoir layer does not exceed 5 mm.

5. The tire according to claim 1, wherein the axial width WA of said at least one reservoir layer is equal to or greater than 20 mm.

6. The tire according to claim 1, wherein said at least one reservoir layer extends axially from one axial end of the crown reinforcement to the other axial end of the crown reinforcement.

7. The tire according to claim 1, wherein the tire includes at least two reservoir layers, at least one of said reservoir layers being placed on either side of the median plane of the tire.

8. The tire according to claim 7, wherein the axial width WA of each of said at least two reservoir layers does not exceed 60 mm.

9. The tire according to claim 7, wherein each of said at least two reservoir layers extends axially over at least 15 mm on either side of an axial end of the crown reinforcement.
